(19) United States
(12) Patent Application Publication
(10) Pub. No.: US 2023/0170838 A1
(43) Pub. Date: Jun. 1, 2023

(54) Solar Panels Over Water Reservoir System

(71) Applicant: MIME, LLC, Brighton, CO (US)

(72) Inventor: Ruben D. Hernandez, Brighton, CO (US)

(21) Appl. No.: 18/058,919

(22) Filed: Nov. 28, 2022

Related U.S. Application Data
(60) Provisional application No. 63/264,606, filed on Nov. 28, 2021.

(51) Int. Cl. H02S 20/20; B61B 5/02; A45B 23/00; E02B 17/00

(52) U.S. Cl. CPC H02S 20/20; B61B 5/02; A45B 23/00; E02B 17/0017; E02B 17/0034; H02S 40/10

(57) ABSTRACT

A system of solar panels over a water reservoir may include a plurality of piers secured to a floor of the water reservoir and extending from the floor to a fixed elevation above a maximum water elevation of the water reservoir. The system of solar panels may also include at least one support structure on the plurality of piers. The system of solar panels may also include a plurality of solar panels supported by the support structure over at least a portion of the water reservoir. The plurality of solar panels both reduce evaporation from the water reservoir and generate solar electricity.

### BACKGROUND

This application claims the priority filing benefit of U.S. Provisional Patent Application No. 63/264,606 filed Nov. 28, 2021 for “Solar Panels Over Water Reservoir System” of Ruben D. Hernandez, hereby incorporated by reference in its entirety as though fully set forth herein.

### BACKGROUND

A big problem for water reservoirs (also known as “certified storage vessels” in Colorado), is that significant water is lost due to evaporation. In some reservoirs there may also be water loss due to vegetation growth on the banks. Water reservoirs also suffer from slope erosion around the perimeter, due to waves. Reservoir operators may attempt to eliminate slope erosion by installing rock or “rip rap” along the shoreline.

### BRIEF DESCRIPTION OF THE DRAWINGS

FIG. 1 is a side cross-sectional view of an example system of solar panels configured over a water reservoir.

FIG. 2 is a partial perspective view of the example system of solar panels over a water reservoir shown in FIG. 1.

FIG. 3 is a top view of the example system of solar panels over a water reservoir shown in FIG. 1.

FIG. 4 shows another example system of solar panels over a water reservoir, including wave and wind deflection.

FIGS. 5 and 6 show an example cart and track of the system of solar panels over a water reservoir.

### DETAILED DESCRIPTION

Solar panel gardens and solar farms are becoming more commonplace as the need for electricity continues to grow. But many people think that solar panel installations are unsightly, and homeowners do not want large installations in their neighborhoods where they see the solar panels.

A system of solar panels which may be installed over a water reservoir is disclosed. In an example, the system includes a plurality of piers secured to a floor of the water reservoir (e.g., to footers or otherwise secured to bedrock or other solid installation surface). The piers extend from the floor to a fixed elevation above a maximum water elevation of the water reservoir, so that the solar panels will always be above the water body surface (e.g., surface of a lake) regardless of the lake fill level. The system of solar panels may also include at least one support structure mounted or otherwise attached on the plurality of piers. The support structure may include a grid made of metal or other suitable material(s), which serves as a base structure or other support for a plurality of solar panels over at least a portion of the water reservoir. The solar panels thus serve to both reduce evaporation from the water reservoir (by shading the water below) and generate solar electricity.

Many water reservoirs are in remote areas where there is no housing development. These water reservoirs are not used for water sports or recreation. Thus, installing solar panels over these water reservoirs enables the land to be used for more than one purpose without impinging on views, public open space, or valuable farmland, as with a typical solar installation. Locating the solar panels over water reservoirs also enables access to the existing electrical grid (e.g., connection at the pump station) to deliver electricity generated by the solar panels.

The solar panel system installed over water reservoirs as described herein may help to reduce evaporation loss by shielding the sun. In Weld county, Colo., the average water loss due to evaporation alone is about 18 to 24 inches per year. Covering just a few acres with the solar panel installation can add up to millions of gallons of water saved from evaporation.

Solar panels in water reservoirs also benefit from the lack of any obstructions (e.g., trees, buildings) that would otherwise shade the solar panels.

The solar panels installed over water can help deter rodents from chewing on the electrical wires.

Another benefit is the multi-use aspect for the land. That is the land space is used for water storage, and the solar panels further produce electrical energy.

Many water storage reservoirs already have pump stations and the associated electricity from the electric grid to power the pump stations. The solar panels thus have access to provide generated electricity onto the power grid. There is no need for extensive and expensive upgrades to the land.

In dedicated water reservoirs, (e.g., Colorado's old gravel pits that are lined with a slurry wall), most are away from housing developments. Some people consider solar gardens as an eyesore. Most of these gravel pits are in rural areas or amongst farmlands. Reusing these for the solar panel installation described herein are therefore out of sight.

The area underneath most of the solar panels will not have to be maintained like in other solar farms or solar gardens. Other solar farms and gardens need to have the vegetation maintained so as to not overgrow and shade the panels. In the areas above high-water level, the solar panels and the shading fabric can block the sun to minimize vegetation growth which will reduce reservoir maintenance. The solar panels may also prevent algae growth in the reservoir by blocking some of the direct sunlight.

Access roads, fences, and maintenance roads are already in place for many water reservoirs. No added expense is needed when installing solar panels over water reservoirs.

Solar panels are best installed on a level ground, water reservoirs are at a fixed elevation or level across the reservoir. The solar panels are at a fixed elevation over the high-water level; thus, the water level will not impact the solar panels as with floating panels. Water reservoirs are made to be filled and emptied at will, thus the ground mounted system does not affect the usability of a water reservoir as with floating panels. In addition, floating panels create their own carbon footprint in the manufacturing of the pontoons to float the panels on the water.

It is also noted that solar panels are more efficient (e.g., 10-20% more efficient) when the surface stays cooler (e.g., about 77 degrees Fahrenheit). It is an added benefit of the system described herein to have the solar panels installed over a body of water to help keep the solar panels cooler.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the examples described herein are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

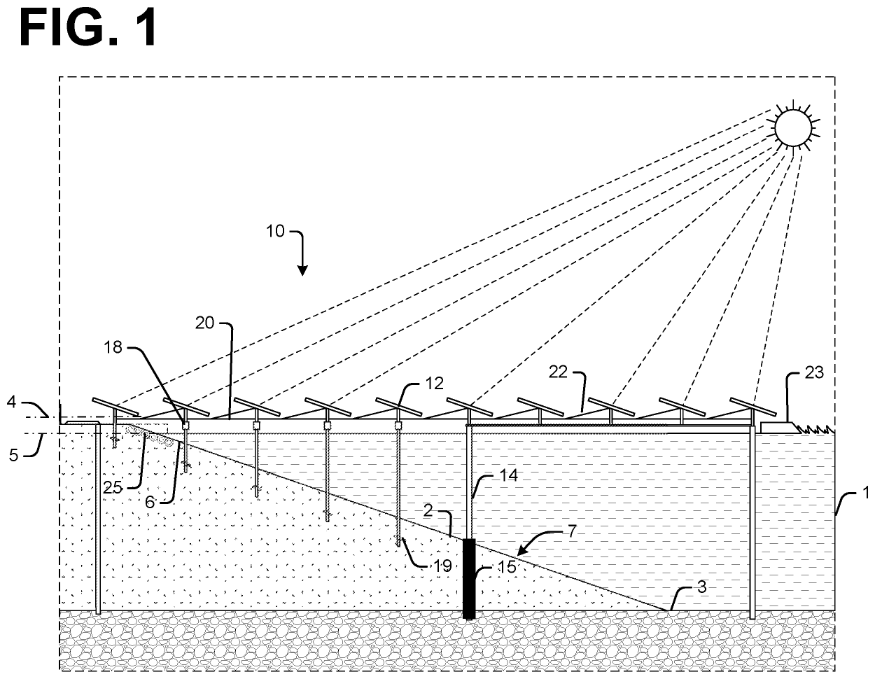

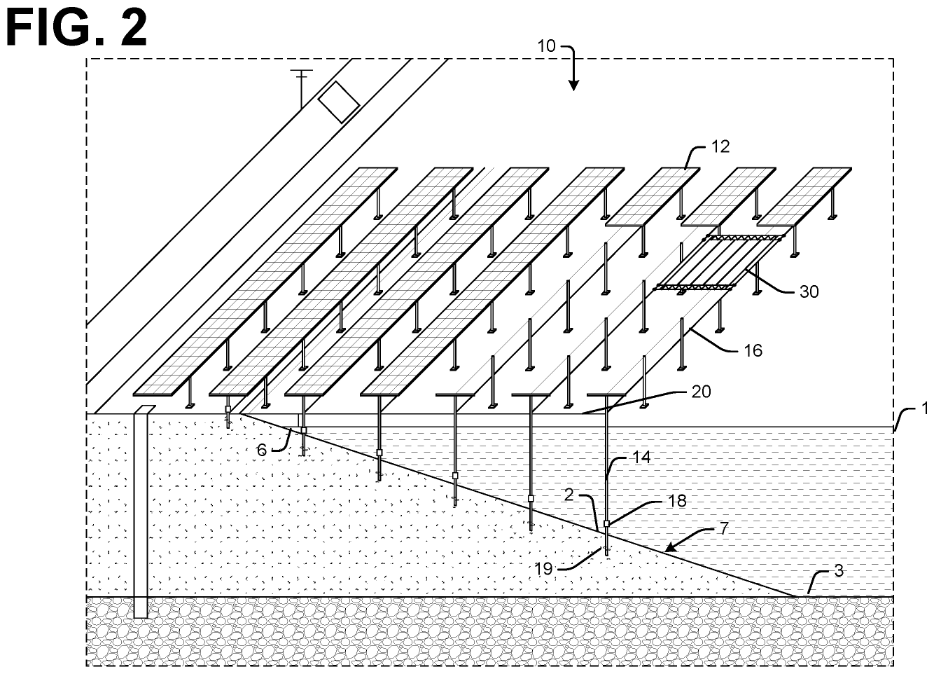

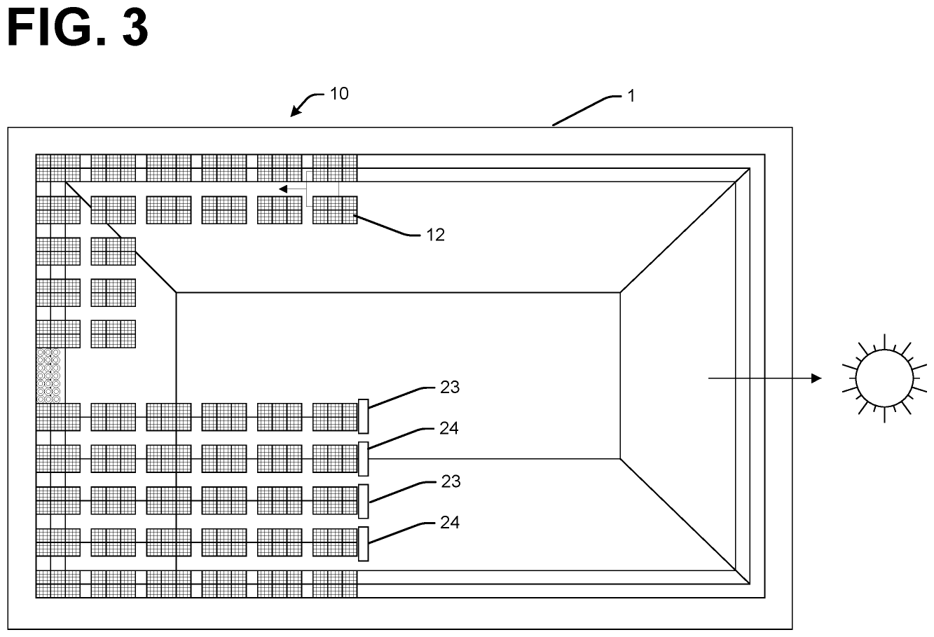

FIG. 1 is a side cross-sectional view of an example system 10 of solar panels 12 configured over a water reservoir 1. FIG. 2 is a partial perspective view of the example system 10 of solar panels 12 over a water reservoir 1 shown in FIG. 1. FIG. 3 is a top view of the example system 10 of solar panels 12 over a water reservoir 1 shown in FIG. 1. Various patterns (e.g., seen in the top view of FIG. 3) of solar panels 12 may be laid out over the water reservoir 1 and/or portions thereof. The patterns may be based on design considerations, such as but not limited to available sunlight for the solar panels, wind and other environmental factors, base substrate available for the footers, etc.

An example system 10 of solar panels 12 installed over a water reservoir 1 includes a plurality of piers 14. The piers 14 may be secured in a ground surface or floor 2 of the water reservoir 1. In an example, the piers 14 may be helical piers (e.g., “screw-in” piers) installed into the ground (e.g., to bedrock or other firm foundation 3). In another example, the piers are installed on footers 15, such as those formed by concrete or other base material. The piers 14 extend from the floor 2 to a fixed elevation 4 above a maximum water elevation 5 of the water reservoir 1.

In an example, at least one support structure 16 is mounted or otherwise attached on the piers 14. The support structure 16 provides a mounting structure for the solar panels 12. The solar panels 12 are configured over at least a portion of the water reservoir (e.g., along the shoreline) to both reduce evaporation from the water reservoir (e.g., by shading the water below) and generating solar electricity.

In an example, the piers 14 are arranged from an upper portion 6 of a bank of the water reservoir 1 and down to a lower portion 7 of a slope of the water reservoir. This configuration at least partly covers the shoreline of the water reservoir 1 with the solar panels 12. Of course, the piers 14 may be installed further into the water reservoir, for example, as shown in FIGS. 1-3.

In an example, the upper portion 6 of the bank of the water reservoir 1 is above the maximum water elevation 5 of the water reservoir 1. As such, the water level will not touch or cover the solar panels 12. In an example, the lower portion 7 of the bank of the water reservoir 1 is below a minimum water elevation of the water reservoir. As such, at least some water in the water reservoir will be covered by the solar panel installation even when the water level drops.

In an example, the system 10 includes one or more anchors and/or weights. Any suitable anchor and/or weight may be used. The anchor(s) and/or pier(s) may be configured to eliminate wind uplift on the solar panels 12. The term “anchor” refers to a securing mechanism (e.g., the lower portion 19 of the helical pier) and/or mass attached (directly or via rope or chain) at or near the bottom of the piers 14. The term “elevated weight” refers to a mass attached above the ground such as on or to an upper portion of the piers 14.

In an example, an elevated weight 18 may be provided on one or more of the piers 14. By way of illustration, the elevated weight 18 may be a basket or box that is attached to the pier 14 and filled with concrete, liquid, sand, soil and/or gravel. In an example, a basket/box made from HDPE or similar material can be attached to the helical pier and filled with native soils (sand and gravel) for added weight against high winds, in lieu of a concrete anchor.

In an example, the system 10 includes a cross bracing 20 for the support structure 16. The cross bracing 20 is configured to stabilize the solar panels 12 against side to side movement that may be caused by waves and/or wind.

In an example, the system 10 includes one or more shade device 22. The shade device 22 may be provided between adjacent solar panels 12 or groups of solar panels 12 (in either direction, front-to-back and/or side-to-side). The shade 22 is configured to further reduce evaporation from the water reservoir 1. For example, the shade may be cloth or other suitable material. The shade 22 may also be made of metal or plastic. The shade 22 may also be configured to deflect wind and/or reduce or eliminate uplift on the plurality of solar panels. The shade 22 further hinders birds from nesting on, under, or near the solar panels 12. For example, the shade 22 may be shiny to deter birds. The shade 22 may also be configured to block sunlight (e.g., made from a low or no transmittance material). This may be particularly advantageous along at least a portion of shoreline of the water reservoir 1 to reduce or eliminate vegetation growth, thereby reducing vegetation water consumption from the water reservoir 1 and reducing or eliminating at least some maintenance at the water reservoir 1 otherwise resulting from having to remove vegetation, leaves, etc. from the water reservoir.

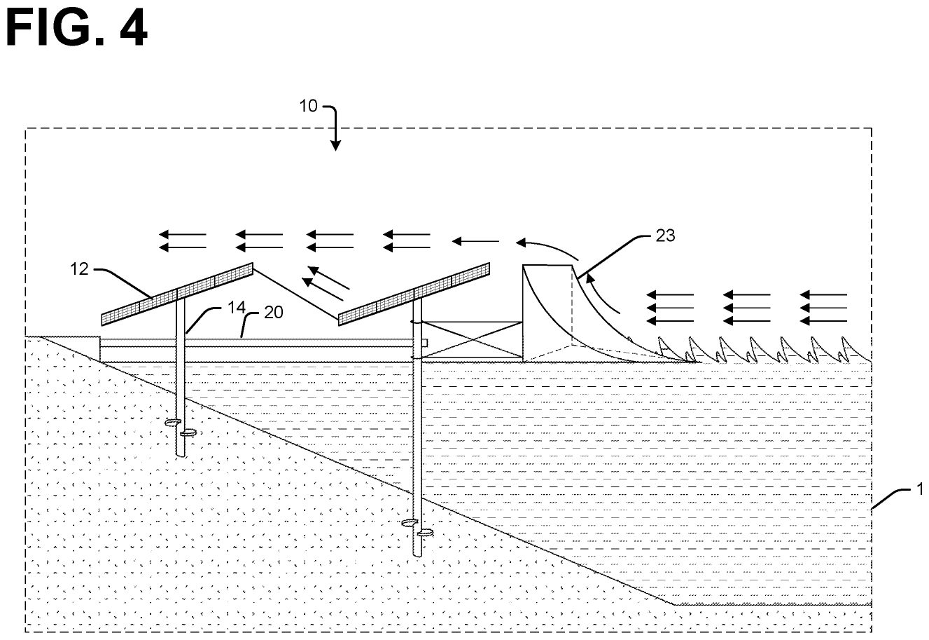

FIG. 4 shows another example system of solar panels over a water reservoir, including wave and wind deflection. In an example, the system 10 includes a wave deflector 23 configured adjacent the support structure 16. The wave deflector 23 may be selected to decrease freeboard (i.e., the distance or space between an upper surface of water in the water reservoir 1 and the solar panels 12). That is, the wave deflector 23 may be selected such that wave height is reduced by a predetermined amount so as to determine the height of the solar panels 12 above the surface of the water, while accounting for waves that are kept in check by the wave deflector 23. This may increase water storage capacity of the water reservoir 1, and may also reduce or eliminate slope erosion.

By way of illustration, one or more wave breakers (see, e.g., detail of FIG. 4) decreases the amount of freeboard needed, thus increasing water storage. High water elevation is a 4933 feet with 3 feet of freeboard factored in. By reducing or stopping waves, there is a possibility to reduce the free board that is needed to only 2 feet. This will increase water storage by ˜80-acre feet or 2.6 million gallons.

In an example, the wave deflector 23 may also be configured as a wind deflector to reduce or eliminate uplift on the solar panels. In another example, a separate wind deflector 24 may be provided to deflect wind and reduce or altogether eliminate uplift on the solar panels 12. Uplift is a major problem that can damage the support structure 16 and/or solar panels 12. The elevated weight/footer 18 described above can also help eliminate the uplift due to high winds.

In an example, implementing one or more wave deflector 23 and/or wind deflector 24, or other wave reducers or wave breakers may be positioned between the rows of solar panels 12. Positioning may be determined based on conditions at the water reservoir 1 to reduce wind and/or waves.

In an example, reducing waves and/or wind can reduce or eliminate slope erosion along the shore of the water reservoir 1. It is noted that tires 25 (e.g., old or recycled) can also be provided for slope stabilization/erosion. Tires 25 may also replace the need for rip rap along the shoreline, thus further saving natural resources and repurposing material to reduce shore erosion and keeping the tires out of the landfill. This helps reduce the amount of waste and material (old tires) going to landfills. The solar panels 12 may also be configured to at least partially hide the tires 25 so as not to be an eyesore.

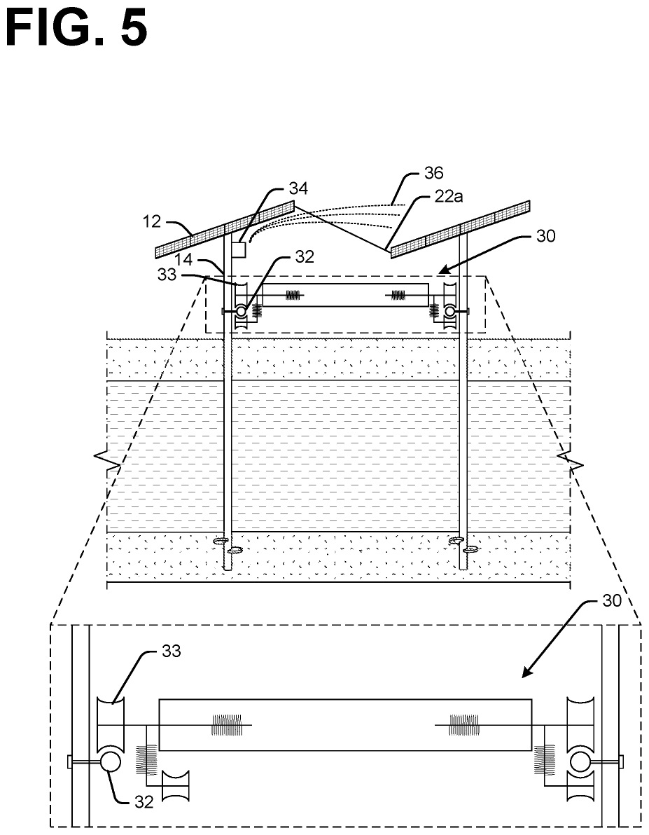

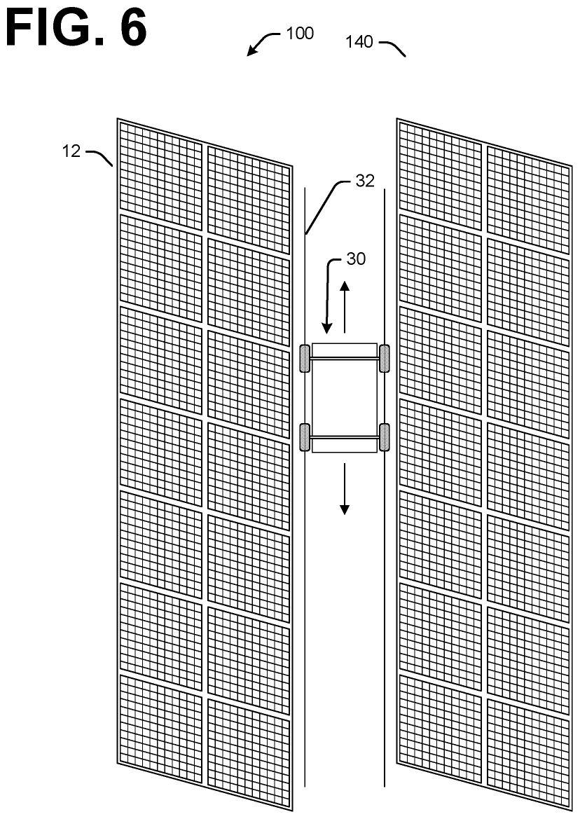

FIGS. 5 and 6 show an example cart 30 and track 32 of the system 10 of solar panels 12 over a water reservoir 1. In an example, the system 10 includes a track 32 for the support structure 16, and a maintenance cart 30 slidable (e.g., via wheels 33) along the track 32 to provide access to the plurality of solar panels 12 for cleaning and maintenance. In an example, the track 32 may be a horizontal bar may be attached to the rows of solar panels 12 that also serves as a stabilizer to keep the panels from swaying (racking) side to side. The horizontal bar may also be used for the maintenance cart 30 to access the solar panels 12 for cleaning and maintenance.

In an example, the system 10 includes a sprinkler system 34 connected to water from the water reservoir 1 and configured to automatically spray the water 36 onto the solar panels 12 for cleaning. The spent water may be recovered back to the water reservoir 1 (e.g., by simply draining off of the solar panels 12 and back into the water reservoir 1.

A method of providing solar panels over a water reservoir is also disclosed. The method may include securing a plurality of piers 14 to a floor of the water reservoir 1 to extend from the floor to a fixed elevation above a maximum water elevation of the water reservoir 1. The method may also include arranging the piers 14 from an upper portion of a bank of the water reservoir 1 and down to a lower portion of a shoreline slope of the water reservoir. The solar panels 12 may be arranged from the top of the bank/crest to the bottom of the reservoir slope (e.g., as shown in FIG. 1). Concrete piers 14 may extend to the reservoir floor (e.g., to bedrock) and/or installed on footers on the bedrock. The piers 14 add more area for solar panel installation.

The method may also include attaching at least one support structure 16 to the piers 14, and cross bracing 20 the support structure 16 to stabilize against side to side movement by waves and wind. The method may also include supporting a plurality of solar panels 12 over at least a portion of the water reservoir 1 to reduce evaporation from the water reservoir and generate solar electricity.

In an example, the method may also include selecting wave deflector 23 to decrease freeboard between an upper surface of water in the water reservoir 1 and the solar panels 12 to increase water storage capacity in the water reservoir and reduce or eliminate slope erosion

In an example, the method may also include shading an area between adjacent solar panels or groups of solar panels to further reduce evaporation from the water reservoir and block sunlight along at least a portion of shoreline of the water reservoir to reduce or eliminate vegetation growth. In an example, the method may also include deflecting wind to reduce or eliminate uplift on the plurality of solar panels.

In an example, fabric or other shade is provided between the rows of solar panels (e.g., as shown in FIG. 2) to shield the water in the water reservoir 1 from the sun, thereby reducing or even eliminating evaporation altogether. Shielding the sun at the top of the bank may also hinder or even eliminate the ability of vegetation to grow along the banks, reducing water consumption from trees and plants and minimizing or entirely eliminating at least some maintenance at the water reservoir 1.

Example 1: Solar panels are installed on the shoreline of a water reservoir along the slope from elevation 4935 ft to elevation 4900 ft and shading 26.66 acres. In this example, the evaporation loss is 18 to 24 inches per year (info from Randy Ray Director of CCWCD). Using the average of 20 inches, on 26.66-acres, 46.65-acre feet of water or 15+ million gallons of water is saved per year.

Example 2: Solar panels are installed on or in water detention/retention ponds, such as Amazon's distribution center in Thornton, Colo. The building has rooftop solar panels, but solar production could be increased by about 30-35% by installing panels over the detention pond, without reducing water storage volumes mandated by state building codes.

It is noted that the examples shown and described are provided for purposes of illustration and are not intended to be limiting. Still other examples are also contemplated.

1. A system of solar panels over a water reservoir, comprising:
a plurality of piers secured to a floor of the water reservoir and extending from the floor to a fixed elevation above a maximum water elevation of the water reservoir;
at least one support structure on the plurality of piers; and
a plurality of solar panels supported by the at least one support structure over at least a portion of the water reservoir, the plurality of solar panels both reducing evaporation from the water reservoir and generating solar electricity.

2. The system of claim 1, wherein the plurality of piers are arranged from an upper portion of a bank of the water reservoir and down to a lower portion of a shoreline slope of the water reservoir to at least partly cover the shoreline of the water reservoir with the plurality of solar panels.

3. The system of claim 2, wherein the upper portion of the bank of the water reservoir is above the maximum water elevation of the water reservoir.

4. The system of claim 2, wherein the lower portion of the bank of the water reservoir is below a minimum water elevation of the water reservoir.

5. The system of claim 1, further comprising a footer subsurface for each of the plurality of piers.

6. The system of claim 1, further comprising an elevated weight for each of the plurality of piers configured to eliminate wind uplift on the plurality of solar panels.

7. The system of claim 6, wherein the elevated weight is a basket or box attached to at least some of the plurality of piers and filled with sand, soil and/or gravel.

8. The system of claim 1, further comprising a cross bracing for the support structure, the cross bracing stabilizing the plurality of solar panels against side to side movement by waves and wind.

9. The system of claim 1, further comprising a track system for the support structure, and a maintenance cart slidable along the track system to provide access to the plurality of solar panels for cleaning and maintenance.

10. The system of claim 1, further comprising a shade between adjacent solar panels or groups of solar panels, the shade configured to further reduce evaporation from the water reservoir.

11. The system of claim 10, wherein the shade further deflects wind and reduces or eliminates uplift on the plurality of solar panels.

12. The system of claim 10, wherein the shade further hinders birds from nesting under the plurality of solar panels.

13. The system of claim 10, wherein the shade blocks sunlight along at least a portion of shoreline of the water reservoir to reduce or eliminate vegetation growth, thereby reducing vegetation water consumption from the water reservoir and reducing or eliminating at least some maintenance at the water reservoir otherwise resulting from the vegetation growth.

14. The system of claim 10, wherein the shade is a fabric shade.

15. The system of claim 1, further comprising a wave deflector configured adjacent the at least one support structure, the wave deflector selected to decrease freeboard between an upper surface of water in the water reservoir and the plurality of solar panels and thereby increase water storage capacity in the water reservoir and reduce or eliminate slope erosion.

16. The system of claim 1, wherein the wave deflector is further configured as a wind deflector to reduce or eliminate uplift on the solar panels.

17. The system of claim 1, further comprising a wind deflector.

18. The system of claim 1, further comprising a sprinkler system connected to water from the water reservoir and configured to automatically spray the water on the plurality of solar panels for cleaning, wherein spent water is recovered back to the water reservoir.

19. A method of providing solar panels over a water reservoir, comprising:
securing a plurality of piers to a floor of the water reservoir to extend from the floor to a fixed elevation above a maximum water elevation of the water reservoir
arranging the plurality of piers from an upper portion of a bank of the water reservoir and down to a lower portion of a shoreline slope of the water reservoir;
attaching at least one support structure to the plurality of piers;
cross bracing the at least one support structure to stabilize against side to side movement by waves and wind; and
supporting a plurality of solar panels over at least a portion of the water reservoir to reduce evaporation from the water reservoir and generate solar electricity.

20. The method of claim 19, further comprising:
selecting wave deflector to decrease freeboard between an upper surface of water in the water reservoir and the plurality of solar panels to increase water storage capacity in the water reservoir and reduce or eliminate slope erosion;
shading an area between adjacent solar panels or groups of solar panels to further reduce evaporation from the water reservoir and block sunlight along at least a portion of shoreline of the water reservoir to reduce or eliminate vegetation growth; and
deflecting wind to reduce or eliminate uplift on the plurality of solar panels.
